(19) United States
(12) Patent Application Publication
(10) Pub. No.: US 2007/0131372 A1
(43) Pub. Date: Jun. 14, 2007

(54) Phyllosilicate Slurry For Papermaking

(76) Inventors: Michael T. Plouff, Charleston, SC (US); Lester W. House, Forest, SC (US)

Correspondence Address: B. CRAIG KILLOUGH, P. O. DRAWER H, CHARLESTON, SC, 29402, US

(21) Appl. No.: 11/562,130

(22) Filed: Nov. 21, 2006

Related U.S. Application Data
(60) Provisional application No. 60/749,220, filed on Dec. 9, 2005.

(51) Int. Cl. D21H 17/68; D21H 17/62; D21H 17/29; C08L 91/00; C08J 3/02; C09K 17/40

(52) U.S. Cl. 162/158; 162/181.8; 162/180; 162/175; 106/287.17; 106/238; 106/228

(57) ABSTRACT

There is provided a slury of phyllosilicate-containing, material and a non-reactive, non-monomeric sizing agent, and water such that the final Hercules apparent viscosity of the slurry is below 100 cps. These slurries may have a solids content from 20 wt. % to 55 wt. % of solid phylloisilicate material. The addition of a phyllosilicate material to a combination of essentially non-reactive, non-monomeric rosin-derived sizing agent does not require the addition of an electrolyte and provides additional stability to rosin dispersions or dispersions of fine rosin particles. In another aspect of the invention there is provided a process of making paper by forming an aqueous cellulosic suspension, mixing a highly concentrated bentonite slurry into an cellulosic suspension, draining the cellulosic suspension to form a wet sheet and drying the wet sheet. A polymeric retention aid may be added to the cellulosic suspension during papermaking.

The contents of Provisional Application U.S. Ser. No. 60/749,220 filed Dec. 9, 2005, on which the present application is based and benefit claimed under 35 U.S.C. §119(e), is herein incorporated by reference.

### BACKGROUND OF THE INVENTION

1. Field of the Invention

This invention relates generally to aqueous phyllosilicate material-containing slurries. More particularly, the present invention relates to a process for papermaking that includes the addition of a bentonite-containing slurry having a tall oil derivative or a rosin derived blend of surfactants mixed into an aqueous cellulosic suspension and forming paper.

2. Description of the Prior Art

Bentonite clay slurries are used in the wet-end of the paper machines as an assisting agent to enhance water removal and retain fine particles during papermaking. Additionally, mineral fibers may be added to pulp slurries to improve color, opacity, printability and other properties. One such papermaking method is disclosed in U.S. Pat. No. 3,052,595 wherein a mineral filler, such as kaolinite, titanium dioxide, talc and the like, bentonite, and an acrylamide polymer are added to a pulp slurry to improve filler retention. Another paper making process having improved retention of pulp components in paper is disclosed in .U.S. Pat. No. 4,305,781 and is especially useful for making unfilled papers such as kraft, linerboard and newsprint. In this process the pulp suspension includes bentonite in an amount generally less than 5%. Polyacrylamides are then added to the suspension to provide improvement in dewatering properties and fiber retention.

Usually bentonite is brought to the paper mill in a dry form that is subject to “dusting” during handling. Expensive and cumbersome equipment must be employed to prepare a bentonite-containing slurry for introduction to the paper machine. It is expensive to automate such equipment, so that additional labor resources must be devoted to preparing the bentonite. A slurry or dispersion made off-site solves some of these problems. However, it is not economical or practical to ship clay suspensions as aqueous slurries because of the large amount of water. Attempts to increase the amount of bentonite in the slurry before shipping have not proven successful as bentonite in slurry form, at solids concentrations above 8% to 10% is thixotropic, forming a gel-like or very viscous dispersion when prepared at above a few percent solids.

There have been repeated attempts to provide pumpable bentonite slurries but most attempts relate to uses in oilfield applications. In U.S Pat. No. 5,779,785 there is disclosed a process for providing a clay slurry containing elevated solids that includes along with the clay a salt of a low molecular weight amine in an amount that is effective to prevent the clay from swelling; thus permitting the slurry to be stored and shipped. The inhibiting effect of the amine salt is reversible upon subsequent dilution. However, the patent does not address enhanced drainage and retention performance compared to the normal bentonite system starting with dry powder.

U.S. Pat. No. 6,045,657 is directed to paper making processes including microparticulates which utilizes bentonite and provides the bentonite in the form of a concentrate at the paper mill. A cellulosic suspension is formed by diluting the bentonite slurry to 15% to 40% dry weight of bentonite in water. To the composition a citrate in a fluid stabilizing and activating amount is added. A polymeric retention aid, such as a cationic starch may be mixed into the cellulosic suspension. While mention is made of the concentrates themselves no mention is made of their enhanced drainage and retention performance compared to the normal bentonite system starting with dry powder.

Despite the efforts of to produce a concentrated slurry, it remains desirable to provide an improved stable bentonite slurry with the characteristics of a pumpable viscosity range and to provide enhanced drainage and added water repellency to the finished paper.

It is an object of the present invention to provide an alkaline earth phyllosilicate material-containing slurry having increased solids content and providing water repellency to paper.

Another object of the present invention is to provide a phyllosilicate-containing slurry for use in papermaking having improved drainage.

A further object of the present invention is the provision of a process four using the slurry of the present invention in papermaking.

There is provided a concentrated slurry of phyllosilicate-containing material and a non-reactive sizing agent. The respective amounts phyllosilicate and sizing agent are present such that the final Hercules apparent viscosity of the slurry is below 100 cps. These slurries may have a solids content above 20 wt. % and as high as 55 wt. % of solid phyllosilicate, and overall above 60 wt % solids of active material, Examples of non-reactive, non-nonomeric sizing agents include various forms of tall-oil and gum rosin, alone or in combination with other materials, such as lignosulfonates, tall-oil fatty acids, styrene compounds, fluorocarbons, acrylic emulsions and styrene acrylates, stearates and stearic acid. The sizing agent is preferably a non-monomeric, rosin-derived blend of surfactants not requiring the addition of electrolyte.

Another aspect of this invention provides a process of making paper according to the following steps: forming an aqueous cellulosic suspension, mixing an non-activated bentonite aqueous dispersion into the cellulosic suspension, draining the cellulosic suspension to form a wet sheet and drying the sheet, wherein the non-activated bentonite aqueous dispersion is added to the cellulosic suspension in the form of a stable fluid, bentonite concentrate or a dilute bentonite dispersion of 20% to 50% by weight of bentonite including a rosin-derived blend of a fluid stabilizing amount of dispersant or other surfactant such that the concentrate has an apparent viscosity (Hercules, bob A, spring 200, 4400 rpm) of below 100 cps. It was found that a slurry of bentonite or other swellable clay and a non-reactive sizing agent when applied in a microparticle retention system, namely, one in which a polymeric retention aid is added to the cellulosic suspension, provides enhanced drainage and retention of fine particles in liquid-solid separation of cellulosic materials during manufacture paper or paperboard, water repellency to the resulting fibrous or cellulosic substrate and additional stability to rosin dispersions or dispersions of fine rosin particles.

Other objects, features and advantages of the present invention will become apparent from the following detailed description of the invention taken in conjunction with the accompanying drawings.

### BRIEF DESCRIPTION OF THE DRAWING

Having described the invention in general terms, reference will now be made to the accompanying drawings which are not necessarily drawn to scale, and wherein:

FIG. 1 illustrates a laboratory scale dynamic drainage analyzer used to demonstrate the efficiency of drainage of aqueous cellulosic suspensions containing the bentonite dispersions of the present invention;

FIG. 2 is a graph comparing the drainage time for aqueous cellulosic suspensions containing the bentonite dispersions of the present invention slurry of this invention to cellulosic suspensions containing bentonite dispersions and polyacrylamide flocculants;

FIG. 3 is a graph showing the drainage time of another aqueous cellulosic suspensions of this invention compared to cellulosic suspensions containing bentonite dispersions and polyacrylamide flocculants;

FIG. 4 is a bar graph showing the drainage time of cellulosic suspensions having various combinations of flocculants and various drainage aids;

FIG. 5 is a bar graph showing the HST in seconds of cellulosic suspensions of recycled pulp and a bentonite slurry containing a rosin size; and

FIG. 6 is a graph showing the drainage of cellulosic suspensions of recycled pulp containing various amounts of dispersed size.

### DESCRIPTION OF THE PREFERRED EMBODIMENT(S)

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be through and complete, and will fully convey the scope of the invention to those skilled in the art.

One aspect of the present invention is the provision of a highly concentrated phyllosilicate material-containing slurry. The phyllosilicate material-containing slurries of the present invention are capable of achieving solids contents above 20% and as high as 55 wt. % of solid phyllosilicate material but usually between about 20% and 50% by weight solids, The overall solids content may be above 60% solids of active material. The results are achieved by the addition of a phyllosilicate material to an essentially non-reactive, non-monomeric rosin-derived sizing agent that does not require the addition of electrolyte results in providing a highly concentrated slurry having additional stability to rosin dispersions or dispersions of fine rosin particles. No activation of the phyllosilicate material is needed as a result of this composition. The amount of sizing agent present in the concentrated slurry is such that the final Hercules apparent viscosity of the concentrated slurry is below 100 cps (Bob: A, Spring:200, 4400 rpm). This rheological profile is important in that under the shear conditions of a pump or the Hercules viscosity test the viscosity is low allowing for ease of use. The viscosity under low shear conditions, such as with Brookfield viscosity measurements is relatively high. Typical Brookfield viscosity for the described invention is approximately 2000 cps (60#4 spindle).

The preferred phyllosilicate material used in the slurry, of this invention is bentonite clay and may be one of the common commercially available bentonites (known as montmorillonite clays).

A preferred non-reactive, non-monomeric sizing agent useful to make the concentrated slurry of high solids content is a rosin acid or rosin acid derivative. While the preferred rosin acid or rosin acid derivative is obtained from tall oil, it will be understood by those skilled in the art that the rosin acid may be obtained from other sources such as gum rosin. Another preferred non-reactive, non-monomeric sizing agent is a potassium rosinate or sodium rosinate. Rosin derivatives are products from a Diels-Alder reaction of rosin and fumaric acid or maleic anhydride. The resulting adducted species has a higher acid content and upon saponification yields a water soluble product. The rosin acids are a blend in a form-type that is solubilized, dispersed, and saponified. When the polyfunctional rosin acid derivative is present in a solid form it is finely dispersed, such that the particle size of the dispersed rosin is less than 2 μm, and preferably less than 0.5 μm.

The slurry may also include blends of acids selected from the group consisting of fatty acids and rosin acids. Preferably, the rosin and fatty acid derivatives are the only dispersion stabilizers in the concentrated slurry. As stated, the non-reactive, non-monomeric sizing agents used in the slurries of the present invention include various forms of rosin, alone or may be used in combination with other materials, such as lignosulfonates, tall-oil fatty acids, styrene compounds, fluorocarbons, acrylic emulsions and styrene acrylates, stearates and stearic acid.

The highly concentrated slurries of this invention may be prepared by diluting the non-reactive, non-monomeric, rosin-derived liquid size, such as a rosin soap size in water. To this solution is added a controlled amount of phyllosilicate material under agitation, followed by additional surface active agents as necessary. Alternatively, the sequence of addition can be reversed, such that a phyllosilicate material-containing slurry is first formed and this is followed by addition of sizing agents, but in the preferred embodiment the all liquid components are present in solution and the solid components are dispersed into the liquid using an appropriate mixing technique. This mixing technique can involve high shear mixing or homogenization depending on the final solids desired of the slurry. After several minutes to several hours, the final viscosity is reached in the highly concentrated slurry such that the viscosity is (Brookfield, 60 rpm, spindle 4) below 3000 cps.

A preferred process of making the highly concentrated slurry comprises blending bentonite and a rosin size, rosin acids, rosin esters, and additional materials as needed such that the final ionic character is anionic. In another aspect of the invention the process of making the concentrated slurry comprising blending alkaline earth bentonite and rosin acids, rosin esters, arid additional materials as needed such that the final ionic character is cationic.

Examples of reactive sizing agents in an alternative embodiment of the concentrated slurry include alkenyl, succinic anhydride, alkyl ketene dimer acid chlorides, acid anhydrides, alkyl isocyanates, rosin anhydrides, etc. These agents might be added in only small amounts and do not constitute more than 2-3% by wt. based on solid material and are only slight enhancements; thus do not constitute the essence of the invention.

In another embodiment of this invention a paper-making process is provided in which, an aqueous cellulosic suspension is formed by mixing the highly concentrated bentonite slurry described above into a cellulosic suspension, typically in an amount of 0.02 to 2% dry weight, the cellulosic suspension is drained to form a wet sheet and the wet sheet is then dried. The cellulosic suspension can be made from relatively pure pulp or from pulp having a relatively high cationic demand, or containing various impurities as can be found in modern systems. The bentonite slurry is added to the cellulosic suspension as either a stable, fluid, bentonite concentrate or by diluting the concentrate substantially immediately before mixing the diluted bentonite dispersion with the cellulosic suspension.

It is particularly preferred to apply the paper making process of this invention to a microparticulate paper making processes, timely processes in which a polymeric retention aid is added to the cellulosic suspension, generally after the last point of high shear (for instance in the head box immediately prior to drainage). The polymer can be non-ionic, anionic or cationic depending on the nature of the aqueous papermaking environment. The polymer can be anionic or non-ionic but is often cationic. It can be a natural material such as cationic starch but is preferably a synthetic polymer.

The shearing can be due merely to turbulence along a duct but preferably it is caused by passage through a centriscreen or other cleaning device or a fan pump or a mixing pump or other device for deliberately applying shear. Preferred shearing processes are described in, for instance, U.S. Pat. Nos. 4,753,710, 4,913,775 and 4,969,976 each of which is hereby incorporated by reference.

The optimum amount of polymeric retention aid can be determined by routine experimentation and will depend upon the nature of the cellulosic suspension and, inter alia, on whether or not low molecular weight high charge density cationic polymer and/or cationic starch and/or other dry strength resin has been incorporated in the suspension, all as described in the aformementioned patents. The polyrmeric retention aid is cationic starch or a synthetic cationic polymer having molecular weight above 500,000.

The slurry of phyllosilicate-containing material (e.g., bentonite or other swellable clay) that when applied in a microparticle retention system provides both (1) enhanced drainage and retention of fine particles in liquid-solid separation of cellulosic materials during manufacture of paper or paperboard and (2) water repellency to the resulting fibrous or cellulosic substrate.

The invention also includes processes in which the novel concentrate is used for other purposes. For instance it can be used in pulp dewatering, paper sludge dewatering, liquid solid separation processes, effluent clarification, inky waste water clarification all in paper-related industries, and it can be used in other industries. The slurries of this invention are useful in separating water from fiber and solids in applications such as papermaking or wastewater sludge treatment when applied as part of a microparticle system and is useful in providing water repellency to a web or fibrous mat such as paper and paperboard. The water repellency of the final sheet as a result of the applied slurry during papermaking can be enhanced by the addition of other nop-reactive or reactive sizing agents during preparation of the slurry.

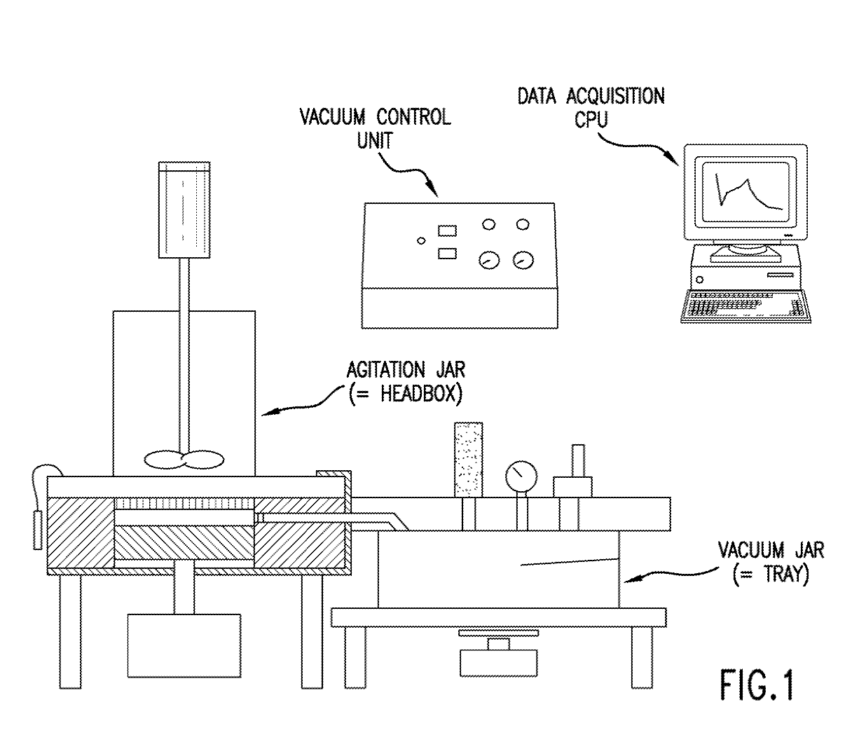

A dynamic drainage analyzer, such as the one shown in FIG. 1, was used to demonstrate the efficiency of drainage and retention in papermaking in the following examples. The analyzer includes of an agitation jar (simulating a headbox) for chemicals and cellulosic suspension, a screen through which water can drain via an automated vacuum system, and controls for data acquisition (CPU). A shorter drainage time (measured at the inflection point of each curve) in the dynamic drainage analyzer translates to better performance on the paper machine.

EXAMPLE 1

This example provides a comparison between the drainage rate for a standard fiber stock sample retention process using the drainage and sizing aid in accordance with invention (“DSA 157”) in an amount of 10 lb/T compared to the following: (1) a polyacrylamide flocculant retention aid, e.g. Nalco 7530 or Cytec 4516; (2) a silica drainage aid, i.e., Eka Nobel NP320, and (3) a microparticle, i.e., Nalco 8678, a lignosulfonate drainage aid. The standard fiber stock sample was 20% broke, 70% hardwood and 10% pine at a stock consistency DDA of 1.1-1.2% and a pH of 4.1-4.3. Dilution water from the tray was provided by PMS (no drainage aid residuals). Blend chest stock (rawCSF) was 650 mL. All sample runs contained 20 lb/ton of slurry of alum and 10 lb/T of size, with the exception of 10 DSA, which has a rosin based dispersant blended in accordance with the invention in place of separately added sizing agent.

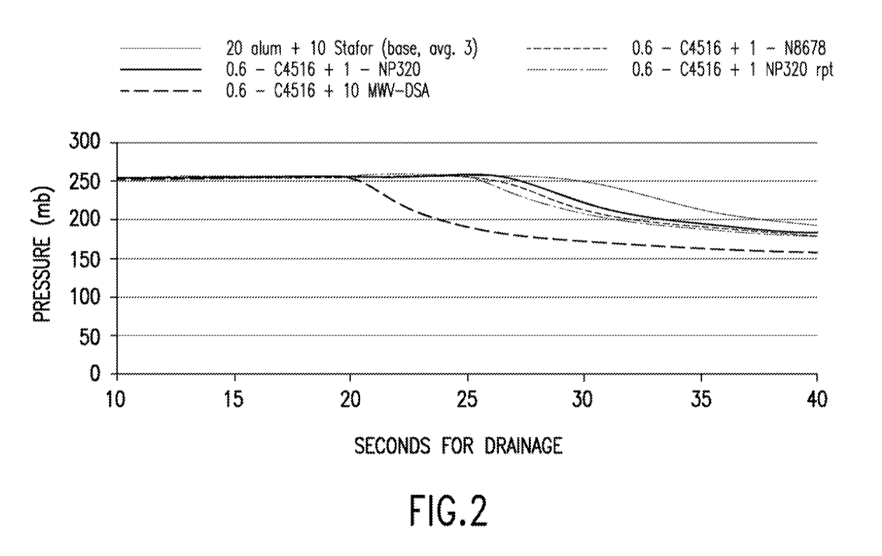

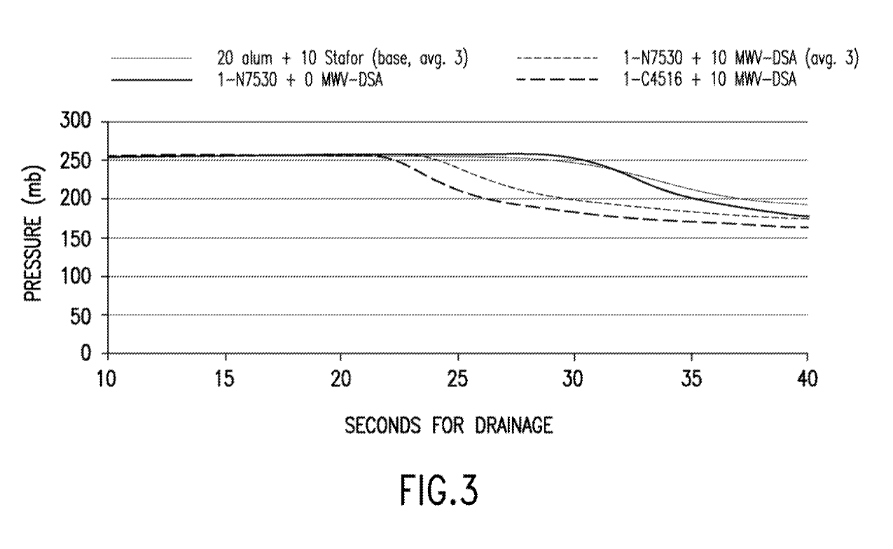

The results illustrated in the samples runs of FIG. 2 show that the stock sample containing a rosin-based dispersant blended in accordance with the invention (DSA) and the polyacrylamide flocculant (C4516) as the retention aid had the fastest drainage time. Similar results are shown in FIG. 3 wherein the fastest drainage time is shown by stock sample containing a rosin-based dispersant blended in accordance with the invention (DSA) and the polyacrylamide flocculant (C4516) as the retention aid.

### EXAMPLE 2

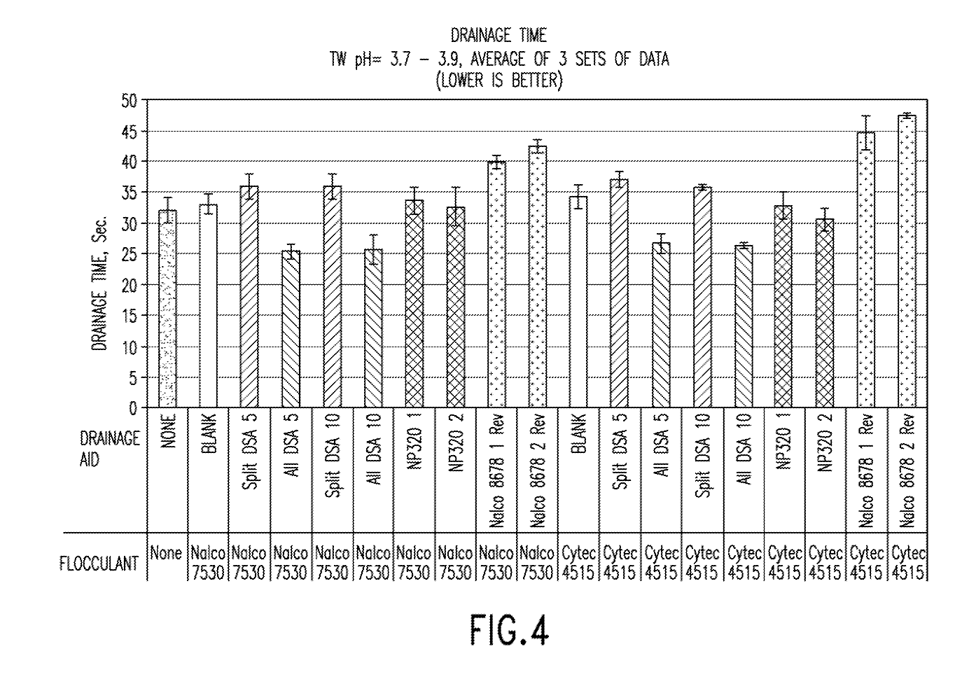

In this example the constant total amount of alum and rosin size in the papermaking suspension was 10 lb/T size and 20 lb/T alum. Slurry and total rosin was adjusted to maintain this level. The slurries contained a different rosin blend than the rosin size, but on a total solids basis in the suspension the quantity of rosin is always the same. In some of the runs all the rosin in the papermaking suspension was with the slurry, and in others it was split between 50% being added in with alum and 50% being provided by the slurry. The results are shown in FIGS. 4-6.

In FIG. 4, the bars are coded by Drainage Aid. For example: “Split DSA 5” refers to 5 lb/T bentonite in the DSA, with the size dosage split-fed, 5 lb/T with the DSA and 5 lb/T fed initially with the alum. “Nalco 8678 I Rev” refers to 1 lb/T of N8678 drainage aid, but fed in Reverse Order, with drainage aid first and flocculant second. “NP320 1” has 1 lb/T of NP320 silica, “NP320 2” has 2 lb/T silica, etc. All flocculants were fed at 1.0 lb/T; and “None” refers to just 20 lb/T alum and 10 lb/T Stafor-50 fed to the stock under the same conditions as the other runs. “Blank” runs contain 1.0 lb/T flocculant but no drainage aid.

Note that the bars labeled “All DSA 5” and “All DSA 10”, where all of the rosin surfactant is with the slurry and no additional rosin agents are added, has a better drainage response than the split-fed case. This implies that the slurry is a better drainage aid than using a bentonite, by itself and having the rosin agent fed separately, an aspect of the invention that is truly novel and heretofore unexpected. Sizing Response: laboratory handsheet studies show that the sizing response of the slurry is improved by use of the slurry. In the following graph, a higher number for HST gives a better sizing response “separate 3” refers to 3 lb/T of size fed separately from the bentonite (Pitchbent M) whereas “slurry 3” refers to 3 lb/T of size fed in accordance with the current invention.

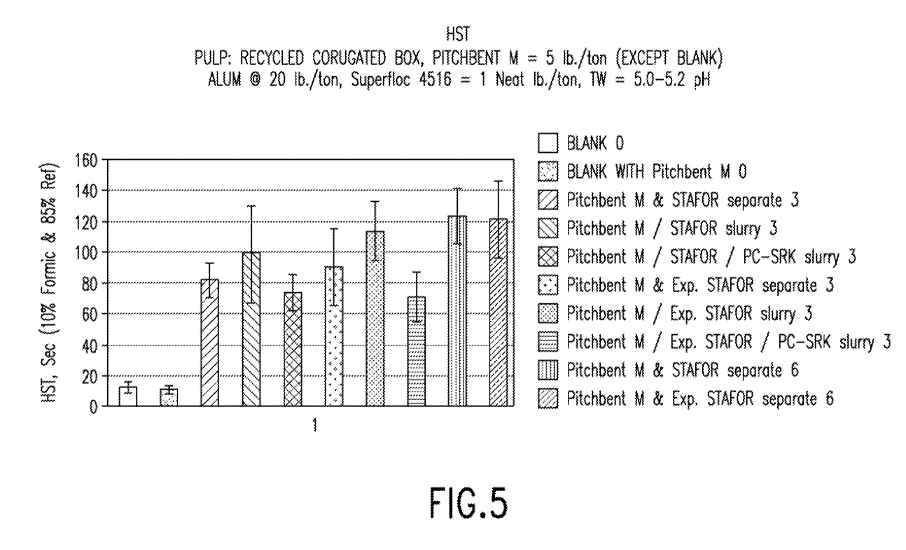

In FIG. 5, there is no statistical difference between the case “Exp. STAFOR slurry 3” and the two cases “. . . separate 6”, implying that a dosage of 3 lb/T in the slurry is equivalent to 6 lb/T when fed separately.

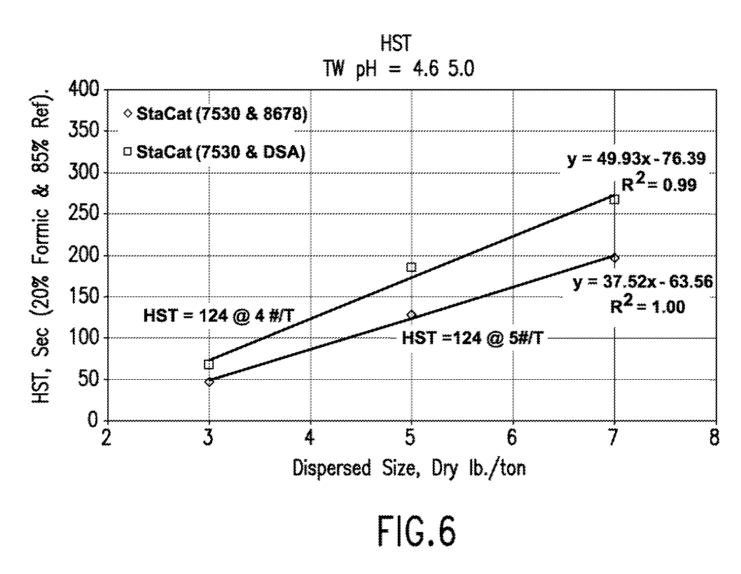

In FIG. 6 a similar trend to the previous graph is shown. The line plotting HS=123 @4#/T shows the sizing response with a fixed amount of bentonite solids in the slurry compared when the bentonite is fed separately. Each of these cases is compared at three levels of size dosage. The HST of 124 with 5 lb/T of size is roughly equivalent to 4 lb/T of size when fed as described in the invention. All other experimental details are equal. This implies a 2.0% advantage for the slurry over the products fed separately.

It is not intended that the examples given here should be construed to limit the invention, but rater they are submitted to illustrate some of the specific embodiments of the invention. Various modifications and variations of the present invention can be made without departing from the scope of the aforementioned claims.

What is claimed is:

1. A composition comprising; alkaline earth phyllosilicate material in an amount of between 20% and 55%, and a non-reactive, non-monomeric sizing agent, and water, wherein said amount of sizing agent is present in an amount such that the final Hercules apparent viscosity of the slurry is below 100 cps.

2. The composition according to claim 1 wherein said phyllosilicate material is bentonite and said non-reactive size is a rosin acid or rosin acid derivative.

3. The composition according to claim 1 wherein said non-reactive, non-monomeric size is a tall-oil rosin or a gum rosin.

4. The composition according to claim 2 wherein said amount of bentonite is 20% to 40% by weight of the composition.

5. The composition according to claim 2 wherein said non-reactive, non-monomeric sizing agent is a potassium rosinate or a sodium rosinate.

6. The composition according to claim 2 wherein said non-reactive, non-monomeric sizing agent further comprises various forms of rosin alone or in combination with a material selected from the group consisting of lignosulfonates, tall-oil fatty acids, styrene compounds, fluorocarbons, acrylic emulsion styrene acrylates, stearates and stearic acid.

7. The composition according to claim 4 wherein said bentonite and said non-reactive, non-monomeric sizing agent are blended together such that the final ionic character is anionic.

8. The composition according to claim 4 wherein said bentonite and said non-reactive sizing agent are blended together such that the final ionic character is cationic.

9. A process of making paper comprising forming an aqueous cellulosic suspension, mixing a highly concentrated bentonite slurry into said cellulosic suspension, draining the cellulosic suspension to form a wet sheet, and drying said sheet, wherein said bentonite slurry is added to the cellulosic suspension in the form of a concentrated bentonite slurry or a dilute bentonite slurry and highly concentrated slurry is 20% to 55% by weight of bentonite and a non-reactive, non-monomeric sizing agent in an amount such that the concentrate has an apparent viscosity (Hercules, bob A, spring 200, 1400 rpm) of below 100 cps.

10. The process of making paper according to claim 9 wherein said bentonite slurry when added to the cellulosic suspension is diluted substantially immediately before mixing the bentonite slurry with the cellulosic suspension.

11. The process of making paper according to claim 9 further comprising mixing a polymeric retention aid into said cellulosic suspension, shearing said suspension, and mixing said bentonite slurry into said sheared suspension.

12. The process of making paper according to claim 11 wherein said polymeric retention aid is cationic starch or a synthetic cationic polymer having molecular weight above 500,000.

13. The process of making paper according to claim 9 wherein said non-reactive, non-monomeric size is a rosin acid or rosin acid derivative.

14. The process of making paper according to claim 9 in which said non-reactive, non-monomeric size is a rosinate and is the only dispersing aid in said bentonite slurry.

15. The process of making paper according to claim 9 wherein said amount of bentonite is 20% to 40% by weight of the said bentonite slurry.

16. The process of making paper according to claim 9 comprising blending bentonite with water and potassium rosinate or sodium rosinate.

17. The process of making paper according to claim 9 wherein said bentonite and said non-reactive, non-monomeric sizing agent are blended together such that the final ionic character is anionic.

18. The process of making paper according to claim 9 wherein said bentonite and said non-reactive, non-monomeric sizing agent are blended together such that the final ionic character is cationic.
